(19) United States
(12) Patent Application Publication
(10) Pub. No.: US 2022/0025870 A1
(43) Pub. Date: Jan. 27, 2022

(54) BLADE FOR A WIND TURBINE, WIND TURBINE AND METHOD OF PREVENTING ICING OF THE BLADE

(71) Applicant: Siemens Gamesa Renewable Energy A/S, Brande (DK)

(72) Inventors: Per Egedal, Herning (DK); Gustav Hoegh, Vejle (DK); Dennis Stachniuk Jensen, Brande (DK)

(21) Appl. No.: 17/312,054

(22) PCT Filed: Oct. 31, 2019
(86) PCT No.: PCT/EP2019/079840

§ 371 Date: Jun. 9, 2021

(30) Foreign Application Priority Data
Dec. 13, 2018 (EP) 18212392.7

(51) Int. Cl. F03D 80/40; F03D 1/06; F03D 7/02

(52) U.S. Cl. CPC F03D 80/40; F03D 1/0633; F05B 2240/3052; F05B 2260/70; F03D 7/0224

(57) ABSTRACT

Provided is a blade for a wind turbine, the blade including a joint section configured to connect the blade to a hub of the wind turbine; an active add-on member which is actuated by a corresponding trim actuator to alter aerodynamic properties of the blade; and a channel configured to supply a medium from the joint section to the active add-on member. A wind turbine and a method of preventing icing of the blade is also provided.

### CROSS-REFERENCE TO RELATED APPLICATIONS

This application claims priority to PCT Application No. PCT/EP2019/079840, having a filing date of Oct. 31, 2019, which is based off of EP Application No. 18212392.7, having a filing date of Dec. 13, 2018, the entire contents both of which are hereby incorporated by reference.

### FIELD OF TECHNOLOGY

The following relates to a blade for a wind turbine, a wind turbine and a method of preventing icing of the blade.

### BACKGROUND

A conventional blade for a wind turbine comprises a joint section configured to connect the blade to a hub of the wind turbine and an active add-on member which is actuated by a corresponding trim actuator to alter aerodynamic properties of the blade. Under cold climate conditions, there is a danger that the active add-on member might freeze and get stuck, and the active add-on member will lose its primary function.

Conventionally, if the active add-on member is stuck in an open or frozen position, the wind turbine will then enter a safe mode with reduced power generation as a consequence.

### SUMMARY

An aspect relates to a blade for a wind turbine and a wind turbine which can prevent the blade from icing.

According to a first aspect of embodiments of the invention, a blade for a wind turbine comprises a joint section configured to connect the blade to a hub of the wind turbine; an active add-on member which is actuated by a corresponding trim actuator to alter aerodynamic properties of the blade; and a channel configured to supply a medium from the joint section to the active add-on member.

Advantageously, the blade is provided with anti-icing means or an anti-icer. The channel provides the medium such as heated air to the active add-on member to prevent the active add-on member from icing. The medium can constantly flow. The flow is low to avoid a too high pressure in situations where the active add-on member is to be closed. This will keep the active add-on member ice free for as long as possible. The blade enables limiting or controlling the icing on the blade, thereby ensuring that the active add-on member keeps operating as designed and maintains the designed turbine load.

The channel comprises a hose or a pipe arranged within the blade.

The channel comprises a first channel section extending from the joint section substantially along a longitudinal direction of the blade and a second channel section extending from the first channel section towards the active add-on member.

According to a second aspect of embodiments of the invention, a wind turbine comprises a tower and a rotor, the rotor being mounted at the top of the tower to rotate about a rotational axis, wherein the rotor has the hub and a plurality of the above described blades. Each blade is connected to the hub via the joint section.

However, there may occur a case where the icing become increasingly severe and the (hot) medium is insufficient to maintain the active add-on member ice free.

The wind turbine further comprises for such a case a first de-icing device configured to detect a first icing condition of the active add-on member, wherein the first de-icing device makes the trim actuator to actuate the active add-on member, if the first de-icing device detects the first icing condition of the active add-on member. More desirable, the first icing condition is detected when a temperature of the blade or an environment thereof is lower than a predetermined temperature.

Advantageously, the forced movement (opening/closing) of the active add-on member can prevent the same from getting frozen, much like pitch motion. This effect could also have a benefit in shedding ice from Vortex Generators (VG's) as the flow there around is changed every time the active add-on member is opened/closed.

However, there may occur another case where the active add-on members do not appropriately respond to the trim actuator if they are completely frozen.

The wind turbine further comprises for such a case a second de-icing device configured to detect a second icing condition of the active add-on member; and a pitch actuator configured to change a pitch angle of the blade, wherein the pitch angle is measured about a longitudinal axis of the blade. The second de-icing device makes the pitch actuator to change the pitch angle of the blade, if the second de-icing device detects the second icing condition of the active add-on member. The second icing condition is detected when an actual movement of the active add-on member does not correspond to a target movement of the active add-on member as determined by the trim actuator.

A turbine of the wind turbine can then slow down and increase the pitch angle to change the flow around the blade to shed ice from the active add-on members, followed by stopping the turbine and pitching the blades perpendicular to the wind so that potentially ice can be shed this way. This strategy can include any pitch angle between an operation angle and stop angle to attempt shedding the ice. When active add-on members start responding normally, the operation can be restored. Alternatively, should it be detected that the active add-on members are completely frozen, and no pitching will shed the ice to restore the normal function, the turbine can be operated without operating the active add-on members.

According to a third aspect of embodiments of the invention, a method of preventing icing of a blade of a wind turbine is provided. The wind turbine comprising a tower and a rotor, the rotor being mounted at the top of the tower to rotate about a rotational axis, wherein the rotor has the hub and a plurality of blades, wherein each blade comprising a joint section configured to connect the blade to the hub of the wind turbine; an active add-on member which is actuated by a corresponding trim actuator to alter aerodynamic properties of the blade; and a channel configured to supply a medium from the joint section to the active add-on member. The method comprises a step of guiding the medium through the channel from the joint section to the active add-on member.

The method further comprises a first de-icing step to detect a first icing condition of the active add-on member; wherein the first de-icing step makes the trim actuator to actuate the active add-on member, if the first de-icing step detects the first icing condition of the active add-on member. More desirable, the first icing condition is detected when a temperature of the blade or an environment thereof is lower than a predetermined temperature.

The method further comprises a second de-icing step to detect a second icing condition of the active add-on member; and a pitch actuator configured to change a pitch angle of the blade, wherein the pitch angle is measured about a longitudinal axis of the blade; wherein the second de-icing step makes the pitch actuator to change the pitch angle of the blade, if the second de-icing step detects the second icing condition of the active add-on member. More desirable, the second icing condition is detected when an actual movement of the active add-on member does not correspond to a target movement of the active add-on member as determined by the trim actuator.

### BRIEF DESCRIPTION

Some of the embodiments will be described in detail, with reference to the following figures, wherein like designations denote like members, wherein:

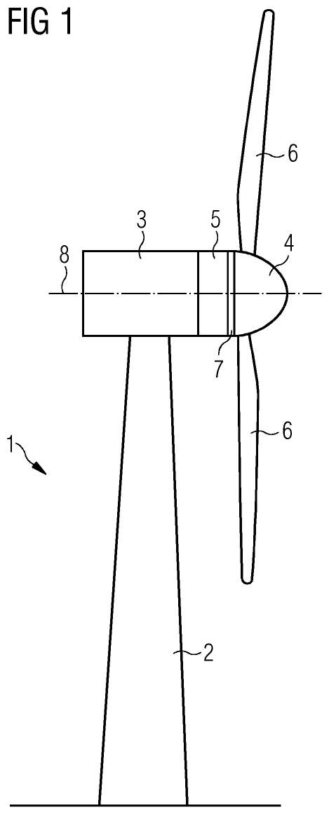

FIG. 1 shows a wind turbine and different elements thereof;

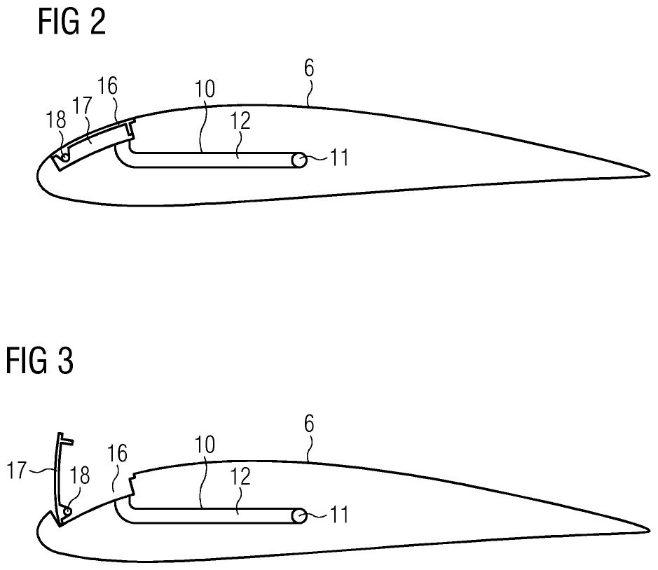

FIG. 2 shows a wind turbine blade having an add-on member; and

FIG. 3 shows the same add-on member in an activated position, where the add-on member is turned to maximum stalling effect.

### DETAILED DESCRIPTION

The illustrations in the drawings are schematically. It is noted that in different figures, similar or identical elements are provided with the same reference signs.

FIG. 1 shows a wind turbine 1. The wind turbine 1 comprises a nacelle 3 and a tower 2. The nacelle 3 is mounted at the top of the tower 2. The nacelle 3 is mounted rotatable with regard to the tower 2 by means of a yaw bearing. The axis of rotation of the nacelle 3 with regard to the tower 2 is referred to as the yaw axis.

The wind turbine 1 also comprises a hub 4 with three rotor blades 6 (of which two rotor blades 6 are depicted in FIG. 1). The blades are connected to the hub 4 via a joint section (not shown). The hub 4 is mounted rotatable with regard to the nacelle 3 by means of a main bearing 7. The hub 4 is mounted rotatable about a rotor axis of rotation 8.

The wind turbine 1 furthermore comprises a generator 5. The generator 5 in turn comprises a rotor 10 connecting the generator 5 with the hub 4. The hub 4 is connected directly to the generator 5, thus the wind turbine 1 is referred to as a gearless, direct-driven wind turbine. Such a generator 5 is referred as direct drive generator 5. As an alternative, the hub 4 may also be connected to the generator 5 via a gear box. This type of wind turbine 1 is referred to as a geared wind turbine. Embodiments of the present invention is suitable for both types of wind turbines 1.

The generator 5 is accommodated within the nacelle 3. The generator 5 is arranged and prepared for converting the rotational energy from the hub 4 into electrical energy in the shape of an AC power.

FIG. 2 shows a wind turbine blade 6 of the wind turbine 1. Each blade 6 has an active add-on member 17 which is actuated by an actuator to alter aerodynamic properties of the blade 6.

The add-on member 17 is designed as a spoiler. The spoiler 17 is here arranged near the front edge of the blade 6 but can also be arranged near the back edge of the blade 6. The add-on member 17 is accommodated in a recess 16 in the blade 6 and can turn about a hinge 18 by activation of the actuator. In FIG. 2, the spoiler 17 is shown in its normal deactivated position, where no spoiler effect and no stall are desired.

FIG. 3 shows the same add-on member 17 in an activated position, where the add-on member 17 is turned to a maximum by the actuator so that the stalling effect is maximum.

According to the embodiments of present invention, the add-on member 17 is not necessarily to be formed as a spoiler. The add-on member 17 can have any other configuration which is able to alter the aerodynamic properties of the blade 6.

The blades 6 further comprise a channel 10 configured to supply a medium from the joint section to the active add-on member 17. The medium can be air. The air can be heated by a heater (not shown) and pumped by a pump (not shown) into the channel 10 under a predetermined pressure. The medium can constantly be supplied to the active add-on member 17, or the medium can be supplied to the active add-on member 17 when a temperature of the blade 6 or an environment thereof is lower than a predetermined temperature. The heater and the pump can be incorporated in the nacelle 3 or the tower 2.

The channel 10 can be formed as a flexible hose or as a rigid pipe arranged within the blade 6. The channel 10 comprises a first channel section 11 extending from the joint section substantially along a longitudinal direction of the blade 6, and a second channel section 12 extending from the first channel section 11 towards the active add-on member 17.

The wind turbine 1 further comprises a first de-icing device configured to detect a first icing condition of the active add-on member 17, wherein the first de-icing device makes the trim actuator to actuate the active add-on member 17, if the first de-icing device detects the first icing condition of the active add-on member 17. If the first icing condition is detected, the active add-on member 17 can constantly be actuated. The first icing condition can be detected when a temperature of the blade 6 or an environment thereof is lower than a predetermined temperature. The first de-icing device can be formed by a temperature sensor which is connected to a controller of the trim actuator.

The wind turbine 1 further comprises a second de-icing device configured to detect a second icing condition of the active add-on member 17, and a pitch actuator configured to change a pitch angle of the blade 6, wherein the pitch angle is measured about a longitudinal axis of the blade 6. The second de-icing device makes the pitch actuator to change the pitch angle of the blade 6, if the second de-icing device detects the second icing condition of the active add-on member 17. The second icing condition can be detected when an actual movement of the active add-on member 17 does not correspond to a target movement of the active add-on member 17 as determined by the trim actuator. Alternatively, the first and second icing conditions can be identical.

In detail, the actual movement of the active add-on member 17, which can be detected by a movement sensor, and can be compared with a target movement of the active add-on member 17. If a difference between the actual movement and the target movement of the active add-on member 17 exceeds a predetermined value, the second icing condition can be detected. The second de-icing device can be formed by the movement sensor which is connected to a controller of the pitch actuator.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A blade for a wind turbine, comprising:
a joint section configured to connect the blade to a hub of the wind turbine;
an active add-on member which is actuated by a corresponding trim actuator to alter aerodynamic properties of the blade; and
a channel configured to supply a medium from the joint section to the active add-on member.

2. The blade according to the claim 1,
wherein the channel comprises a hose arranged within the blade.

3. The blade according to claim 1,
wherein the channel comprises a pipe arranged within the blade.

4. The blade according to claim 1,
wherein the channel comprises a first channel section extending from the joint section substantially along a longitudinal direction of the blade and a second channel section extending from the first channel section towards the active add-on member.

5. A wind turbine comprising a tower and a rotor, the rotor being mounted at the top of the tower to rotate about a rotational axis, wherein the rotor has the hub and a plurality of blades according to claim 1, wherein each blade is connected to the hub via the joint section.

6. The wind turbine according to claim 5,
further comprising a first de-icing device configured to detect a first icing condition of the active add-on member; wherein
the first de-icing device makes the trim actuator to actuate the active add-on member, if the first de-icing device detects the first icing condition of the active add-on member.

7. The wind turbine according to claim 1,
wherein the first icing condition is detected when a temperature of the blade or an environment thereof is lower than a predetermined temperature.

8. The wind turbine according to claim 5,
further comprising a second de-icing device configured to detect a second icing condition of the active add-on member; and
a pitch actuator configured to change a pitch angle of the blade, wherein the pitch angle is measured about a longitudinal axis of the blade;
wherein the second de-icing device makes the pitch actuator to change the pitch angle of the blade, if the second de-icing device detects the second icing condition of the active add-on member.

9. The wind turbine according to claim 8,
wherein the second icing condition is detected when an actual movement of the active add-on member does not correspond to a target movement of the active add-on member as determined by the trim actuator.

10. A method of preventing icing of a blade of a wind turbine, the wind turbine comprising a tower and a rotor, the rotor being mounted at the top of the tower to rotate about a rotational axis, wherein the rotor has the hub and a plurality of blades, wherein each blade comprising a joint section configured to connect the blade to the hub of the wind turbine; an active add-on member which is actuated by a corresponding trim actuator to alter aerodynamic properties of the blade; and a channel configured to supply a medium from the joint section to the active add-on member, wherein the method comprises a step of guiding the medium through the channel from the joint section to the active add-on member.

11. The method according to claim 10, further comprising:
a first de-icing step to detect a first icing condition of the active add-on member; wherein
the first de-icing step makes the trim actuator to actuate the active add-on member, if the first de-icing step detects the first icing condition of the active add-on member.

12. The method according to claim 11,
wherein the first icing condition is detected when a temperature of the blade or an environment thereof is lower than a predetermined temperature.

13. The method according to claim 10,
further comprising a second de-icing step to detect a second icing condition of the active add-on member; and
a pitch actuator configured to change a pitch angle of the blade, wherein the pitch angle is measured about a longitudinal axis of the blade; wherein
the second de-icing step makes the pitch actuator to change the pitch angle of the blade, if the second de-icing step detects the second icing condition of the active add-on member.

14. The method according to claim 13,
wherein the second icing condition is detected when an actual movement of the active add-on member does not correspond to a target movement of the active add-on member as determined by the trim actuator.
